(19) United States
(12) Patent Application Publication
(10) Pub. No.: US 2023/0233396 A1
(43) Pub. Date: Jul. 27, 2023

(54) STRETCHING DEVICE AND METHOD OF USE

(71) Applicant: Janak Patel, Sugar Land, TX (US)

(72) Inventor: Janak Patel, Sugar Land, TX (US)

(21) Appl. No.: 17/583,432

(22) Filed: Jan. 25, 2022

(51) Int. Cl. A61H 1/02

(52) U.S. Cl. CPC A61H 1/024; A61H 1/0266; A61H 1/0244; A61H 2201/1215; A61H 2201/5012; A61H 2001/0203; A61H 2201/5097

(57) ABSTRACT

An apparatus and method for use of an improved stretching device providing various stretches and manipulation of a user's muscle groups, including lower body muscle groups. Movement of the upper and lower support members can be achieved with a controller or wireless controller, such as a cellular phone executing an application operatively connected via a transceiver of the stretching device. The upper support member and lower support member may be independently controlled by a secondary motor assembly at a rotational connection between the support members. Some embodiments may provide removable support members for switching between left and right-side manipulation of a user's left and right legs with a single device. Other embodiments may include a track to allow for a sliding movement of the motor assembly or the upper and lower support members between left and right sides of the stretching device.

### CROSS-REFERENCE TO RELATED APPLICATIONS

Not applicable.

### STATEMENT REGARDING FEDERALLY SPONSORED RESEARCH

Not applicable.

### BACKGROUND

The present invention generally relates to an improved stretching device and method of use.

For additional background and fuller understanding of the muscles involved in the operation of the invention and those sought to be exercised or stretched include the inner thigh muscle group, the gluteus muscle group, the hamstring muscle group, the quadricep muscle group, and calf muscle group. The inner thigh muscle group comprises the adductor brevis, adductor longus, and adductor magnus. The gluteus muscle group comprises gluteus minimus, gluteus maximus, gluteus medius, obturator internis, obturator externus, infer gemellus, superior gemellus, and piriformis. The hamstring muscle group comprises the semimembranosus, semitendinosus, and biceps femoris. The quadricep muscle group comprises gracilis, quadratis femoris, vastus medialis, vastus lateralis, vastus intermedius, rectus femoris, tensor vastus intermedius, quadratus lumborum, iliacus, and tensor fascia latae. The calf muscle group comprises gastrocnemius, soleus, and planataris. Any reference herein to a group of muscle or muscles as described above should be understood to reference at least one muscle identified within the groups above.

The present invention is distinguished over the following prior art:

U.S. Pat. No. 5,122,106 uses a hydraulic actuator to manually stretch the hamstring muscle group. The present invention stretches the hamstring muscle group with control of angle using the motor it allows gradual stretching of the hamstring muscle group without the user exerting their own energy to effectuate the stretch. The present invention also allows for portability and adjustability with the accompanying motor and battery power.

U.S. Pat. No. 5,280,783 appears to use its motor to take the user's leg from a flexed position to a straightening of the leg. The present invention starts in a straight leg position to pivot at the hip joint to stretch the hamstring muscle group. The present invention also allows for portability and adjustability with the accompanying motor and battery power.

US Patent Pub. 2013/0225378 appears to be just a manual apparatus to put the leg up and requires the user to use their own strength to stretch as best as they can. The present invention also allows for portability and adjustability with the accompanying motor and battery power.

WO2016/149354 A1 appears to provide stretching of the hamstring muscle group, but does not include the range of motion, portability, functionality, ease of use, compactness of the present invention.

KR 2006/0118365 appears to focus on strengthening of the abdominal muscle groups and removing fat, if even medically possible. The present invention allows for upwards and downwards movement and rotation of the user's ankles. This reference does not include the range of motion, portability, functionality, ease of use, compactness of the present invention.

U.S. Pat. No. 5,728,048 is directed to exercising and strengthening of the lumbar muscle region and abdominal muscle group, but does not include the range of motion, portability, functionality, ease of use, compactness of the present invention.

U.S. Pat. No. 10,420,691 is similar to U.S. Pat. No. 5,280,783, above, and focuses on stretching the user's leg by straightening of the leg at the knee joint, but does not include the range of motion, portability, functionality, ease of use, compactness of the present invention.

US Patent Pub. 2005/0003935 appears to function with the user sitting upright and exerts undue strain or load upon the user's back and hips and does not isolate the stretching of the hamstring muscle group. This is problematic for users with back problems, who primarily need the hamstring stretch as they would not be able to use the device in this reference without significant pain or aggravation of their preexisting condition. The device of this reference also fails to include the portability, functionality, ease of use, compactness of the present invention.

US Patent Pub. 2006/0160673 this device appears to start the user's leg in a bent or ninety (90) degree angle position and then pushes the user's ankle to provide the additional stretch. User's that are unable to begin a stretch in the position of ninety (90) degrees are unable to use the device of this reference. Further, the motor used in this device does not pivot at the hip joint. The present invention allows the user to begin in a fully extended leg position or one-hundred eighty (180) degrees), and then provides the user a stretch through various degrees of extension or retraction. The device of this reference also fails to include the portability, functionality, ease of use, compactness of the present invention.

### SUMMARY

In some embodiments of the present invention, the present invention is an improved body stretching device and method of use.

In several embodiments, the present invention comprises a novel design and method of providing a user with stretching of the body and leg muscles.

In some embodiments, the stretching device is designed to provide at least ten different stretches for a user's muscle groups. These stretches include, but are not limited to: 1) stretching of the hamstring muscle group, 2) stretching of the gluteus muscle group and or hip stretch with the user's knee flexed; 3) stretching of the gluteus muscle group by positioning a user's foot on the upper support member; 4) stretching of the inner thigh muscle group by putting the user's foot of their first leg on the upper support member and bending their second leg parallel to a floor and positing the foot of the second leg proximate to the knee joint of a first leg; 5) stretching of the calf and/or ankle muscle groups while the user is in a standing position with their foot on the upper support member; 6) stretching of the quadricep and/or hip muscle groups with the user's knee flexed; 7) stretching the inner thigh muscle group by resting the user's leg flat along the upper and lower support members; 8) stretching the gluteus and inner thigh muscle groups by starting in a butterfly position with knees bent and bottoms of feet touching and using the stretching device to manipulate the user's legs; and 9) stretching the hip flexor by the user lying on their stomach with their leg and foot on the support members and elevating the leg. The stretching device may also be used as a device to elevate or lift a user's limb or body part, such as a patient in a hospital bed needing an elevated position for their limb during recovery.

In some embodiments, the stretching device is designed to allow for ease of use, repositioning between stretching configurations, repositioning between left side and right-side body parts relative to the support base. The upper support member and lower support member comprise an upper and lower support member assembly are intended to allow for multiple angles and orientations in relation to the user's body to effectuate different stretches and incorporation of different body parts. In several embodiments, the stretching device is transportable, free-standing, and does not require mounting to a floor or other secured substrate.

In several embodiments, the present invention comprises a lower support base, a lower support member, an upper support member, and a motor assembly. In several embodiments the upper support member may include a bracket for mechanically engaging the motor assembly. In several embodiments, the upper support member at a proximal end is rotationally joined to the support base. In several embodiments, the upper support member at a distal end is rotationally joined to a proximal end of the lower support member. In several embodiments, the lower support member includes a distal end having attached thereto a bracket for engaging a second bracket attached to the motor providing a locking mechanism to secure the upper support member in a position relative to the lower support member. In other embodiments, the rotational joint situated between the upper support member and lower support member is capable of being locked into a set position, such as 180 degrees for straight, 90 degrees for bent knee, and acute angles for further stretching angle, other stretches, or storage and space savings.

Some embodiments may include the capability of the upper and lower support member assembly to be shifted between a left and right side of the support base or removed and reinstalled from a left side to a right side of the support base and vice versa. This may be advantageous as it allows for a single device to effectuate stretches of different body parts on the user's left or right side without the need to have separate machines or operate a machine designed for a certain body part in an improper manner that could result in injury.

In several embodiments, the present invention may comprise a pin mechanism to secure the upper support member in an extended position relative to the lower support member. In other embodiments, the rotating joint of the upper and lower support member assembly may include a pin and receiver mechanism to secure the upper support member at a desired angle relative to the lower support member. In several embodiments, the present invention may comprise a ratcheting joint between the upper support member and the lower support member to secure the upper support member at a desired angle relative to the lower support member. Such ratcheting joint could be tightened via a screw or knob or other fastening device known to those of ordinary skill in the art. In some embodiments of the present invention, a rotational joint between the upper support member and the lower support member may comprise a positive lock or indention mechanism providing pre-set angle settings for the user to select for their desired stretch. In some embodiments, the rotational joint and locking mechanism may be controlled via a remote controller or an application, which may be run from a computer, cellular phone, or tablet device.

In several embodiments, the stretching device may include structural elements, such as a support base, for the purpose of stabilizing the stretching device with a combination of the user's body weight and/or the stretching device. In some embodiments, the user may lay or rest their torso, waist, and/or hips on the support base to stabilize the stretching device.

In several embodiments, the stretching device may include cushioning supports, such as foam pieces or other soft and/or ridged material, and/or retention devices, such as straps or braces for the purpose of stabilizing and supporting a user's knee, ankle, leg, and/or foot to maintain a proper skeletal or muscular mechanical alignment during a stretching maneuver.

In several embodiments, the stretching device may include an electronic controller for operatively connected to and for controlling the actuator motor and/or rotational motor of the upper and lower support member assembly. In some embodiments, the electronic controller may include a handheld or remote control. In other embodiments, the electronic controller may be a personal electronic device, such as a smart phone or tablet, running software designed to communicate and interact with the stretching device.

In several embodiments, the stretching device may include a sliding mechanism adjoining the support base whereby the motor and/or the lower member support can slidably transition between a left and right side of the support base. This slidable mechanism can allow for a single embodiment, as described herein, to provide stretching to both legs of a user without the need to disassemble or have a separate device to stretch both legs. In some embodiments, the sliding mechanism may be achieved with a track in which the motor attached to the upper and lower support member assembly can travel.

The stretching device may include a support base; a motor assembly disposed at a distal end of the support base; an upper support member, the upper support member engaged to the motor assembly at a proximal end of the upper support member; a rotational connection, the rotational connection engaged to a distal end of the upper support member; and a lower support member, the lower support member engaged to the rotational connection at a proximal end of the lower support member. The stretching device may include a controller operatively connected to the motor assembly. The controller may be a wireless controller and the motor assembly may further comprise a transceiver. The wireless controller may be a cellular phone executing source code as an application. The rotational connection may comprise a secondary motor assembly. The controller may be operatively connected to the motor assembly and operatively connected to the secondary motor assembly. The controller may be a wireless controller and the motor assembly may further comprise a transceiver operatively connected to the wireless controller. The secondary motor assembly may further comprise a second transceiver operatively connected to a wireless controller. The transceiver may be operatively connected to the second motor assembly.

The stretching device may comprise a support base; a motor assembly disposed at a distal end of the support base, wherein the motor assembly comprises an extension support; an upper support member; the upper support member engaged to the motor assembly at a proximal end of the upper support member; wherein the upper support member comprises a receiving slot formed at the proximal end of the upper support member for receiving the extension support of the motor assembly; a rotational connection; the rotational connection engaged to a distal end of the upper support member; a lower support member; the lower support member engaged to the rotational connection at a proximal end of the lower support member. The stretching device may also comprise a track formed on a surface of the support base, wherein the motor assembly is slidingly engaged to the track allowing the motor assembly to traverse a length of the track. The stretching device may also comprise a track formed on a surface of the motor assembly, wherein the upper support member is slidingly engaged to the track allowing the upper support member to traverse a length of the track. The stretching device may also comprise a track formed on a surface of the support base, wherein the motor assembly is slidingly engaged to the track allowing the motor assembly to traverse a length of the track. The stretching device may also comprise a track formed on a surface of the motor assembly, wherein the upper support member is slidingly engaged to the track allowing the upper support member to traverse a length of the track.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1A illustrates a side profile of one embodiment of the present invention in a prone starting position.

FIG. 1B illustrates a detailed side profile view of one embodiment of the present invention.

FIG. 1C illustrates a side profile view of one embodiment of the present invention in an elevated position.

FIG. 2A illustrates a side profile view of one embodiment of the present invention in an elevated and contracted position.

FIG. 2B illustrates a side profile view of one embodiment of the present invention in an elevated and contracted position.

FIG. 2C illustrates a side profile view of one embodiment of the present invention in an elevated contracted position.

FIG. 3A illustrates one embodiment of the present invention showing the support member assembly in an elevated position.

FIG. 3B illustrates one embodiment of the present invention showing the support member assembly in an elevated position.

FIG. 3C illustrates one embodiment of the present invention showing the support member assembly in an elevated position.

FIG. 3D illustrates one embodiment of the present invention showing the support member assembly in an starting position.

FIG. 4A illustrates an isometric view of one embodiment of the present invention.

FIG. 4B illustrates an isometric view of a different configuration of the embodiment depicted in FIG. 4A.

FIG. 4C illustrates an isometric view of one embodiment of the present invention showing a mortise and tenon configuration allowing varying positioning of the support member assembly.

### DETAILED DESCRIPTION

One or more illustrative embodiments incorporating the invention disclosed herein are presented below. Applicant has created a revolutionary and improved stretching device and method of use. The stretching device of the present invention provides a variety of stretching movements for various muscle groups. The stretching device allows for an upper and a lower support member to rotate between an elevated and prone position, which when used in conjunction with different placements and orientations of a user's leg or foot provide stretching of the user's various muscle groups.

The devices and methods described herein may be employed in a home or clinic setting (such as physical therapy offices, gyms, health clubs, massage parlors, spas, doctor's offices, chiropractic offices, athletic training facilities, etc.). The range of applications are myriad in that the devices and methods described herein may provide relief from muscle tension, tightness, contractures, assist in injury prevention and recovery, and treatment of various orthopedic and neurological disorders. While the devices and methods of the present invention are described for stretching of muscle groups, other applications may be possible such as back or arm muscle stretches.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted because such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale, and arrangements of specific units in the drawings can vary.

While most of the terms used herein will be recognizable to those of ordinary skill in the art, it should be understood, however, when not explicitly defined, terms should be interpreted as adopting a meaning presently accepted by those of ordinary skill in the art. In cases where the construction of a term would render it meaningless, or essentially meaningless, the definition should be taken from Webster's Dictionary 2020, 11^{th} Edition. Definitions and/or interpretations should not be incorporated from other patent applications, patents, or publications, related or not, unless specifically stated in this specification, or if the incorporation is necessary for maintaining validity. As utilized herein, the following terms have the following definitions.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

As will be discussed in more detail with respect to the various accompanying figures and descriptions, the present invention allows a user to perform a variety of assisted stretches with relative ease and comfort. A user of the present invention can rest their foot against the upper support member while placing their heel on the support base. When the upper support member is rotationally moved from a starting position and towards a 90-degree position relative to the support base, this movement provides a stretch for the user's calf muscle group.

Additionally, a user of the present invention may lay on their back on top of the support base with an upper leg or thigh resting on the upper support member and lower leg or calf resting on the lower support member. In this arrangement, the upper support member and lower support member are arranged at a starting 0-degree angle, prone, or flat position. When the motor provides rotational movement to the upper support member, the user's entire leg, both the upper and lower leg are moved into an elevated position relative to the starting 0-degree, prone, or flat position of the upper and lower support member assembly.

Additionally, a user of the present invention could lay on their back on top of the support base with an upper leg or thigh resting on the upper support member and lower leg or calf resting on the lower support member. In this arrangement, the upper support member and lower support member are arranged at a greater than a 0-degree angle, flexed, or contracted position. When the motor provides rotational movement to the upper support member, the user's entire leg, both the upper and lower leg are moved into an elevated position, but where the knee joint is manipulated into a bent or contracted position.

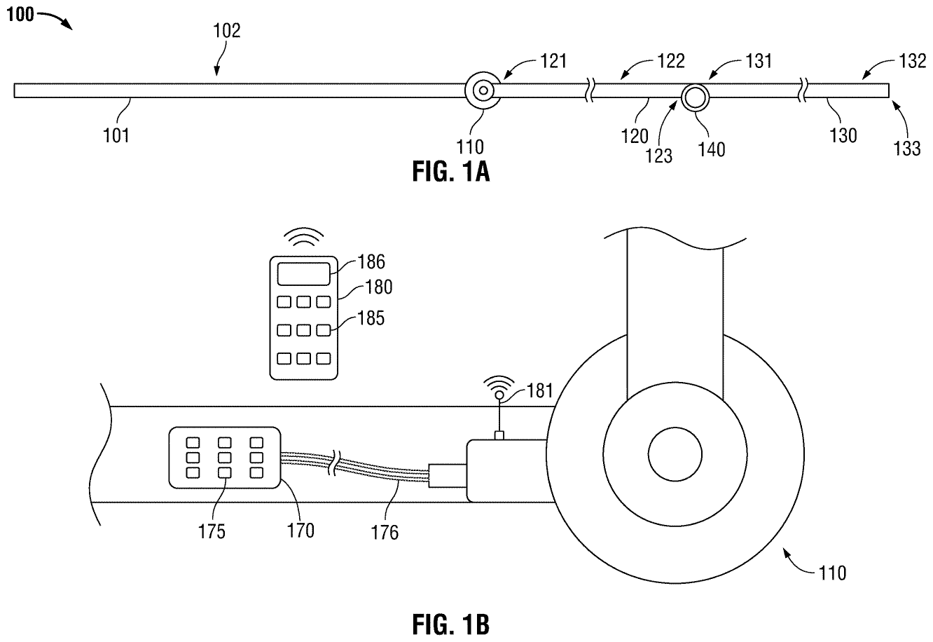

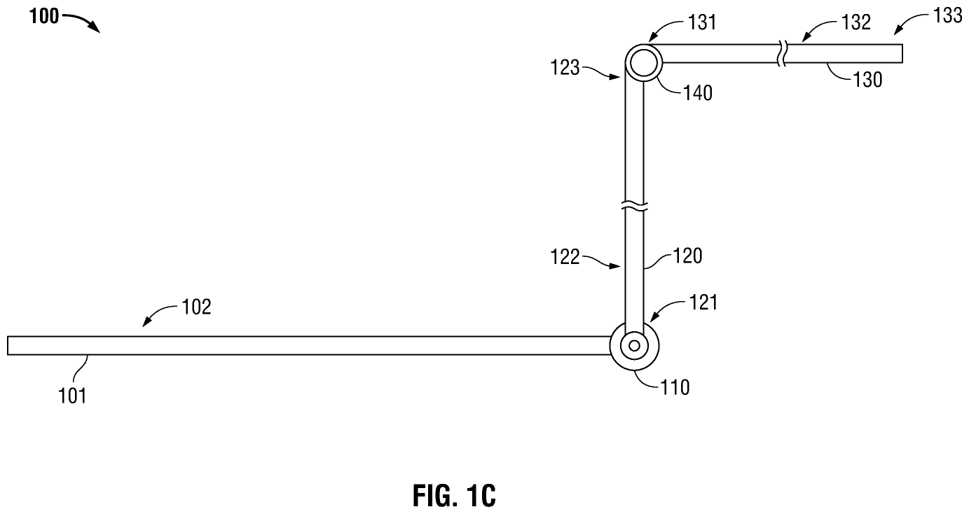

FIG. 1A illustrates a side profile view of one embodiment of the present invention in a starting 0-degree, prone, or flat position. The stretching device 100 includes a support base 101 allowing a user to lay on their back, stomach, or side, or allow a user to stand on one or two feet of the support base top surface 102. Attached to the support base 101 is a motor assembly 110. It should be understood the motor can be of many types of motors and still achieve the same or similar results of the present invention. The motor assembly 110 allows for rotational movement of support members 120 and 130, while remaining in a position fixed relative to the support base 101. This allows for a user's torso or hips to remain in a relatively fixed position, while the support members 120 and 130 are moved into various configurations to provide manipulation of the various muscle groups described herein. The upper support member 120 includes a proximal end 121 attached to the motor assembly 110. The motor assembly 110 provides rotational movement to cause the elevation of the upper support member 120. The rotational movement provided by the motor allows the upper support member to move between a starting 0-degree angle, or parallel to the support base, and an approximately 90-degree angle, or perpendicular to the support base. It should be appreciated that these angles and the arrangement of the motor and support member can be modified to provide hyperextension of a user's joint, or extension beyond a user's typical range of motion for a joint. This of course depends on the type of stretch and starting positions.

The upper support member 120 includes a distal end 123 adjoined to a lower support member 130 via a rotational connection 140, such as a hinge and pin connection or alternatively a secondary motor assembly. It should be appreciated that the rotational connection can include positive stops or an indention and peg system to create predefined angles or settings to allow easier and faster setup for the user. It should also be appreciated that the use of a secondary motor can allow for easier and finer control of the angles through pre-defined settings or finer adjustment without the need for the user to physical remove or secure pins or knobs. Alternatively, the upper support member 120 may include a latch device with a pin that secures the lower support member 130 at an angle relative to the lower support member. In some embodiments, the rotational connection 140 may comprise a secondary motor assembly to power and control the rotation of the rotational connection 140 between, and the angle formed by, upper support member 120 and lower support member 130.

The lower support member 130 includes a distal end 133 wherein some embodiments may include a strap, brace, footrest, or other mechanical device to allow a user to secure their foot, ankle, or leg to the lower support member surface 132. The user of some embodiments of the present invention may rest their torso and/or hips on the surface 102 of the support base 101, their thigh or upper leg on the surface 122 of the upper support member 120, and their calf and/or ankle and/or foot on the surface 132 of the lower support member.

FIG. 1B illustrates an embodiment of a motor assembly 110. The motor assembly 110 is operatively connected to a controller 170 and/or a wireless controller 180 and wireless transceiver 181. Controller 170 may include plurality of buttons, screens, or dials 175 and be operatively connected to motor assembly 110 such as by wires and/or circuitry 176. Wireless controller 180 may include a one or more buttons, screens, or dials 185. The wireless controller 180 may also include a smart phone or table having a touch screen 186 running an application “app” and comprise inputs such as buttons, screens, or dials 185. Wireless controller 180 is operatively connected over a wireless connection to transceiver 181 of motor assembly 110. Such wireless connections may include Bluetooth, Wi-Fi, Internet or “cloud” connectivity. Accompanying circuitry is contained within the controller or alternatively within a housing affixed to a motor housing or support base. The controller includes the capability to actuate the motor to raise or lower the lower support member. Alternatively, the controller may include the capability to actuate rotational connection, sometimes the secondary motor assembly, to raise or lower the upper support member and/or lower support member in relation to each other and provide adjustment of the angle between the two support members. Alternatively, the second controller may include the capability to actuate the rotational connection, sometimes the secondary motor assembly, to raise or lower the upper support member and/or lower support member in relation to each other.

FIG. 1C illustrates the embodiment shown in FIG. 1A in an elevated position that may be achieved during a stretch or body manipulation. In this embodiment, a user of the stretching device 100 may rest their torso and/or hips on the surface 102 of the support base 101, their thigh or upper leg on the surface 122 of the upper support member 120, and their calf and/or ankle and/or foot on the surface 132 of the lower support member 130. The stretching device when in an elevated position will raise the user's thigh from a prone position to a substantially perpendicular position relative to the user's torso. In this particular embodiment, the user's knee joint is bent and their calf or lower leg rests upon lower support member 130. Alternatively in some embodiments, a user may place their heel on the surface 102 of the support base 101 while extending their foot across the motor assembly 110 onto the surface 122 of the upper support member 120. This allows for the user to use the elevated position to stretch and/or manipulate the user's calf, ankle, and/or foot muscle groups.

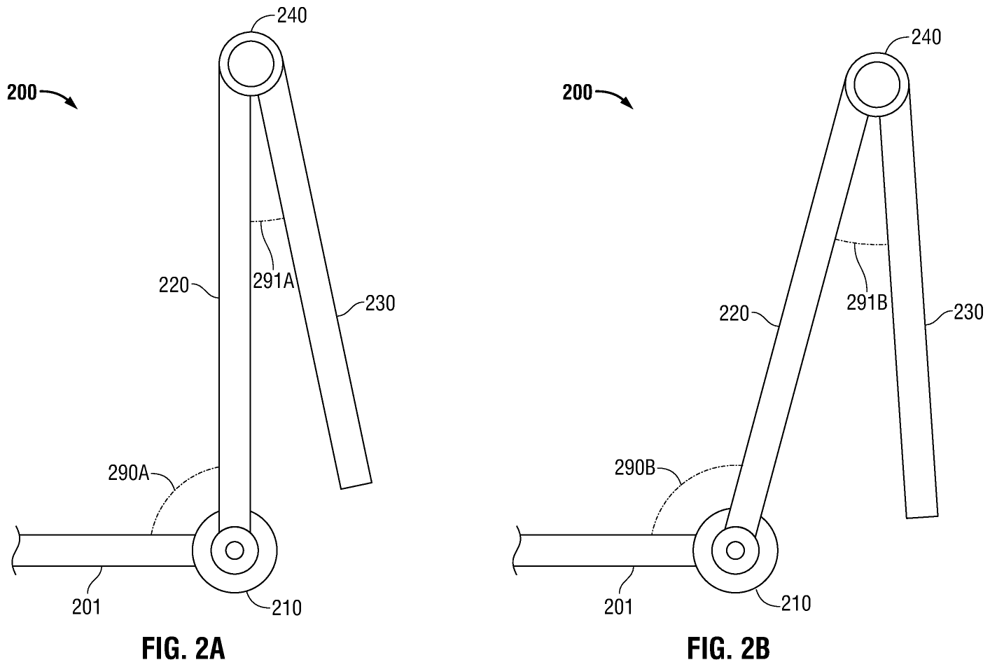

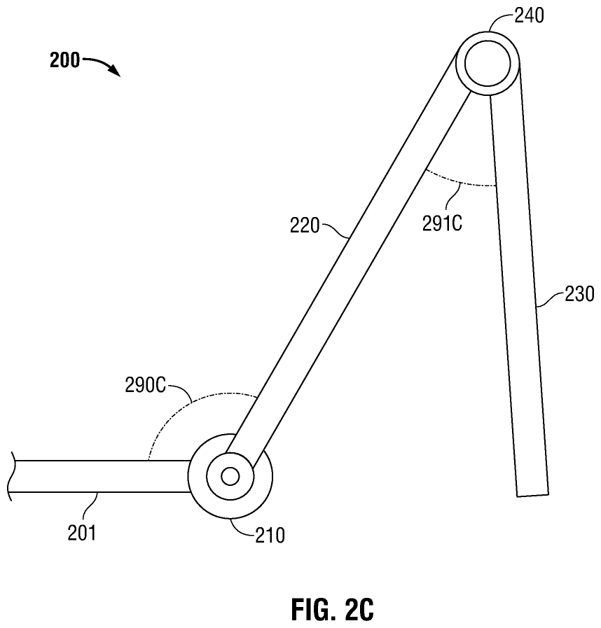

FIGS. 2A-2C illustrate various side profile configurations of several embodiments of the present invention. The stretching device 200 includes positions of support base 201 and upper support member 220 provide an angle 290A with a vertex formed by motor assembly 210. The positions of upper support member 220 and lower support member 230 provide an angle 291A with a vertex formed by rotational connection 240, which may comprise a secondary motor assembly, as described herein. It should be appreciated that some embodiments of the present invention allow for independent control and manipulation of angles 290A and 291A via motor assemblies 210 and 240. This is demonstrated with the alternative illustrations in FIGS. 2B and 2C demonstrating alternative angles 290B, 291B, 290C, and 291C. Alternatively, angles 291A, 291B, and 291C can be manipulated manually by the user using the rotational connections described herein or alternatively through a second motor assembly. Alternatively, motor assembly 210 and rotational connection 240, comprising a secondary motor assembly, may provide automated or assisted manipulation of angles 290A, 291A, 290B, 291B, 290C, and 291C via a controller or wireless controller as described herein. Such manipulation of the various angles allows for the user to experience various stretches and manipulation of body parts as described herein.

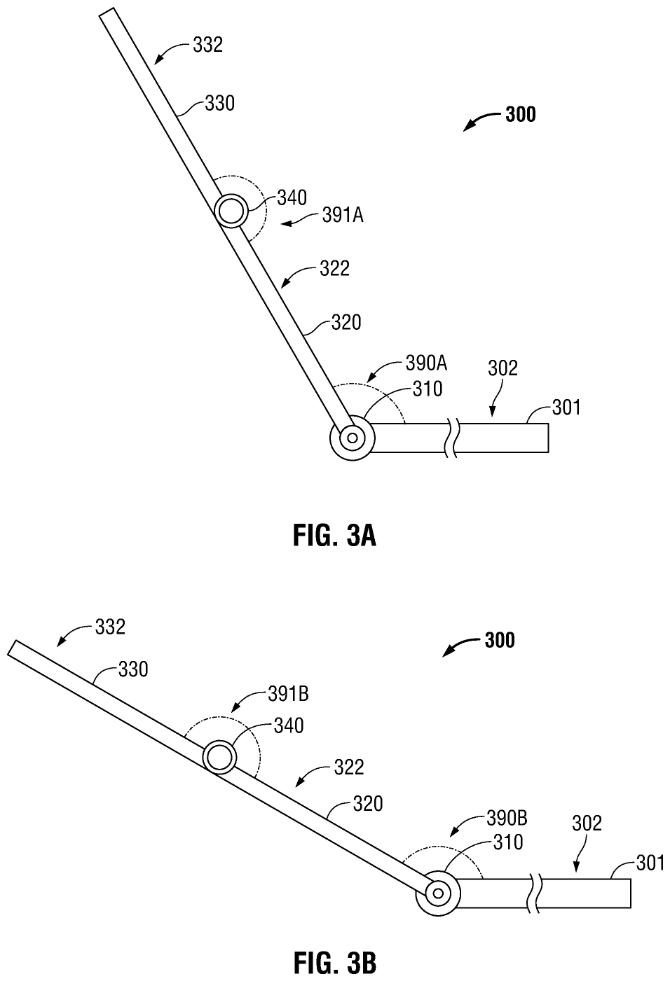

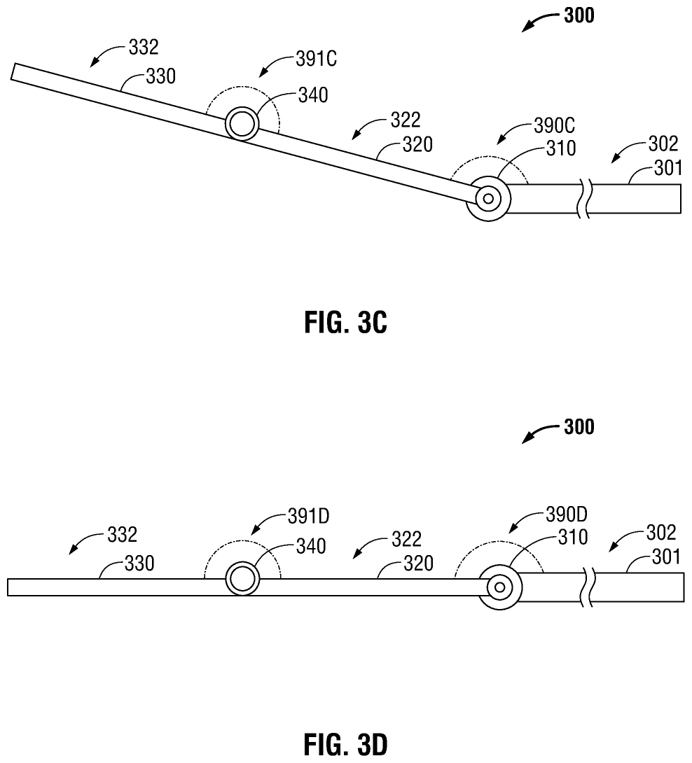

FIGS. 3A-3D illustrate various side profile configurations of several embodiments of the present invention. The stretching device 300 includes support base 301 wherein a user may rest their torso and/or hips on the surface 302 of the support base 301, their thigh or upper leg on the surface 322 of the upper support member 320, and their calf and/or ankle and/or foot on the surface 332 of the lower support member 330. The stretching device 300 when in an elevated position will raise or lower a user's leg from a prone position to an elevated position relative to the user's torso at angle 390A. In this particular embodiment, the user's knee joint remains substantially straight or at approximately 180 degrees while the user's calf or lower leg rests upon the surface 332 of lower support member 330. In this particular embodiment, angle 391A, 391B, 391C, and 391D remains unchanged or substantially unchanged throughout the stretch or manipulation of the user's leg and hip. Motor assembly 310 provides the rotational movement and manipulation of angle 390A, 390B, 390C, and 390D allowing the user of the stretching device 300 to stretch or manipulate their leg and hip muscle groups. This particular embodiment shows the manipulation of angle 390A, 390B, 390C, and 390D through a range of angles until the substantially prone, 0-degree angle is achieved at 390D which may represent a resting or starting position for the stretching device. It should be appreciated that some embodiments may provide stretches by having the user begin in an elevated position and end in a prone position. In some embodiments, the prone or starting 0-degree angle of 390D represents a position where the user's leg is substantially in-line or parallel to the user's torso.

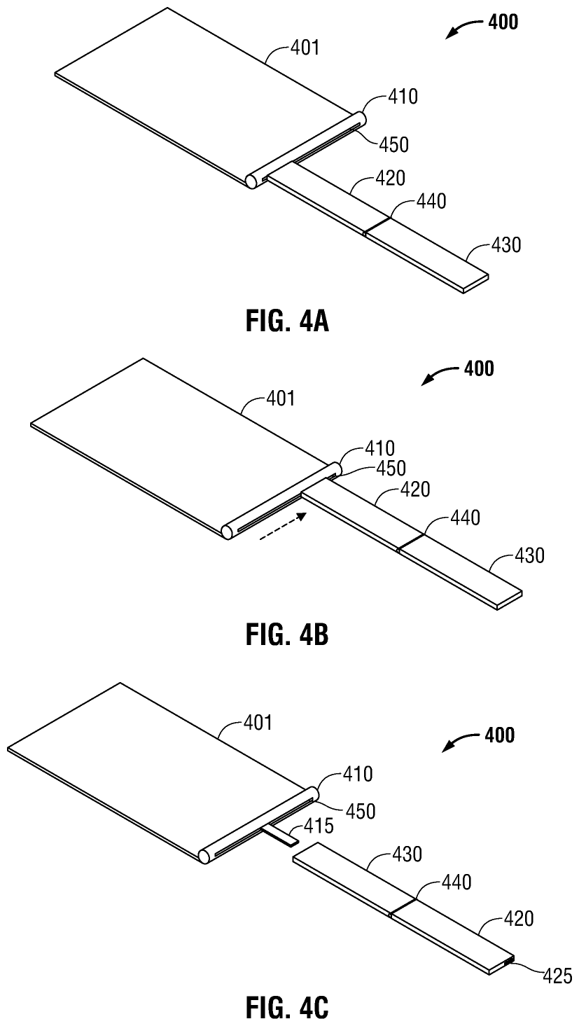

FIG. 4A illustrates an embodiment of the present invention wherein stretching device 400 comprises support base 401, upper support member 420, lower support member 430, motor assembly 410, rotational connection 440, which may comprise a second motor assembly, and track 450. It should be appreciated that some embodiments may have track 450 formed on motor assembly 410 allowing upper support member 420 to travel back and forth along track 450. It should be appreciated that alternative embodiments may have track 450 formed on a surface of support base 401 allowing motor assembly 410 to travel back and forth along track 450. It should be appreciated that track 450 enables the stretching device 400 to provide manipulation to both the left and right side of a user's body with a single device. The motor assembly 410 may include mechanisms and circuitry to provide back and forth movement along track 450 controlled by a controller or wireless controller as described herein.

FIG. 4B illustrates the traversal of track 450 by upper support member 420 along motor assembly 410. It should be appreciated that traversal of the track 450 by upper support member 420 may be performed manually by a user. It should also be appreciated that in alternative embodiments, the traversal of track 450 formed on a surface of support base 401 by motor assembly 410 may be performed manually by a user. It should be appreciated that traversal of track 450 may also be controlled by one or more controllers. It should be appreciated that track 450 may comprise a recessed slot or an external rail. These embodiments allow for a single device to be used for manipulation of a user's left and right side without the need for the user to remove themselves from the support base. Additionally, the sliding arrangement avoids the need to have left-side and right-side version of the stretching device. Additionally, the sliding arrangement allows for a single sized support base to accommodate different body sizes and shapes.

FIG. 4C illustrates an alternative embodiment of the present invention wherein stretching device 400 comprises support base 401, upper support member 420, lower support member 430, motor assembly 410, rotational connection 440, which may comprise a second motor assembly, as described herein, and track 450. Motor assembly 410 further comprises extension support 415 which matingly engages receiving slot 425 of the upper support member 420. This arrangement enables a user to remove the upper support member 420, rotational connection 440, and lower support member 430 for storage. Alternatively, rotational connection 440 may provide rotational movement in both directions enabling the user to reverse the orientation of the upper support member 420 and lower support member 430. This alternative embodiment may enable the user to disengage the upper support member 420 from extension support 415, rotate the upper support member 180-degrees from side to side, wherein a top surface 421 is facing down and a bottom surface 427 is facing up, and then re-engage upper support member 420 to extension support 415 via receiving slot 425. The receiving slot 425 in some embodiments may be offset to one side of upper support member 420 so that upper support member 420 and lower support member 430 can be alternated between a left side orientation and a right-side orientation relative to the support base 401, when upper support member 420 is rotated as described above.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Accordingly, it is intended that the following claims be interpreted to embrace all such variations and modifications.

What is claimed is the following:

1. A stretching device comprising:
a support base;
a motor assembly disposed at a distal end of the support base;
an upper support member, the upper support member engaged to the motor assembly at a proximal end of the upper support member;
a rotational connection, the rotational connection engaged to a distal end of the upper support member; and
a lower support member, the lower support member engaged to the rotational connection at a proximal end of the lower support member.

2. The stretching device of claim 1 further comprising:
a controller operatively connected to the motor assembly.

3. The stretching device of claim 2 wherein:
the controller is a wireless controller, and the motor assembly further comprises a transceiver.

4. The stretching device of claim 3 wherein:
the wireless controller is a cellular phone executing source code as an application.

5. The stretching device of claim 1 wherein:
the rotational connection comprises a secondary motor assembly.

6. The stretching device of claim 5 wherein:
the controller operatively connected to the motor assembly and operatively connected the secondary motor assembly.

7. The stretching device of claim 6 wherein:
the controller is a wireless controller and the motor assembly further comprises a transceiver operatively connected to the wireless controller.

8. The stretching device of claim 7 wherein:
the secondary motor assembly further comprises a second transceiver operatively connected to the wireless controller.

9. The stretching device of claim 7 wherein:
the transceiver is operatively connected to the second motor assembly.

10. A stretching device comprising:
a support base;
a motor assembly disposed at a distal end of the support base, wherein the motor assembly comprises an extension support;
an upper support member, the upper support member engaged to the motor assembly at a proximal end of the upper support member; wherein the upper support member comprises a receiving slot formed at the proximal end of the upper support member for receiving the extension support of the motor assembly;
a rotational connection, the rotational connection engaged to a distal end of the upper support member; and
a lower support member, the lower support member engaged to the rotational connection at a proximal end of the lower support member.

11. The stretching device of claim 10 further comprising:
a track formed on a surface of the support base, wherein the motor assembly is slidingly engaged to the track allowing the motor assembly to traverse a length of the track.

12. The stretching device of claim 10 further comprising:
a track formed on a surface of the motor assembly, wherein the upper support member is slidingly engaged to the track allowing the upper support member to traverse a length of the track.

13. The stretching device of claim 1 further comprising:
a track formed on a surface of the support base, wherein the motor assembly is slidingly engaged to the track allowing the motor assembly to traverse a length of the track.

14. The stretching device of claim 1 further comprising:
a track formed on a surface of the motor assembly, wherein the upper support member is slidingly engaged to the track allowing the upper support member to traverse a length of the track.
